(19) United States
(12) Patent Application Publication
(10) Pub. No.: US 2014/0370856 A1
(43) Pub. Date: Dec. 18, 2014

(54) SYSTEMS AND METHODS FOR CLOUD VOICEMAIL AND TWO WAY COMMUNICATION

(71) Applicant: AppForest LLC, Portland, ME (US)

(72) Inventors: Jeffrey L. Strunk, Eustis, ME (US); Urchie Bertram Ellis, Atlanta, GA (US); Charles Mark Anderson, Greene, ME (US)

(73) Assignee: AppForest LLC, Portland, ME (US)

(21) Appl. No.: 14/312,113

(22) Filed: Jun. 23, 2014

Related U.S. Application Data
(63) Continuation-in-part of application No. 14/213,963, filed on Mar. 14, 2014.
(60) Provisional application No. 61/790,022, filed on Mar. 15, 2013.

(51) Int. Cl. H04M 3/533; H04M 7/00; H04W 4/12

(52) U.S. Cl. CPC H04M 3/53333; H04W 4/12; H04M 7/0042
USPC 455/413

(57) ABSTRACT

In some embodiments, a method for providing answering service via an answering device comprises associating an answering service for a target telephone number of a user with the answering device; enabling the answering device to receive a call directed from a caller device to the target telephone number; storing an answering message; and configuring the answering device to send back the answering message to the caller device in response to receiving the call when a condition is satisfied. Moreover, in some embodiments, the condition is based on a date of the call or a time of the day of the call, a status of a business associated with the target telephone number, an origin of the call or a type of the caller device, or the condition is satisfied when the call is received at a specific occasion.

### RELATED APPLICATION

This application claims priority to U.S. patent application Ser. No. 14/213,963, filed on Mar. 14, 2014, and titled “Systems and Methods for Cloud Voicemail and Two Way Communication,” which itself claims priority to the U.S. provisional patent application No. 61/790,022, filed on Mar. 15, 2013, and titled “AnswerApp”. The entire contents of both applications are incorporated herein by reference.

### TECHNICAL FIELD

The present disclosure relates generally to systems and methods related to telephone answering mechanisms and in particular to bi-directional telephone answering.

### BACKGROUND

Telecommunications answering machines are often hosted by a local exchange carrier (LEC). In order to have such answering machines activated, a business or individual must pay a monthly fee. A representative of the business or the individual accesses the answering machine by, for example, dialing a 10 digit number, navigating through prompt instructions, entering a personalized passcode, and then pressing a designated number to play back the answering machine messages. In order to record or change a message, or to change user options, the individual or business representative must follow additional prompts or procedures.

In some cases, LEC based answering machines may require the user to press up to about twenty button in order to simply update and record an outgoing message. In addition, if the user presses a button by mistake, the user may have to hang up and repeat the whole lengthy time-consuming process. In addition, current carrier based systems limit the number of incoming messages that can be stored. Thus, after a user reaches the limit, any caller attempting to leave a message receives a statement such as “This person's message mailbox is full, please call back later.” The system then terminates the call. Further, existing systems do not provide shortcuts for circumventing the answering machine's greeting and/or instructional prompts such that a user can expediently leave a message. Some carrier answering machines seem to deliberately insert lengthy instructions in order to increase the usage time, and thus the user's cost.

There is a need for an advanced answering system that avoids the above problems. Such an advanced answering system should further provide additional functionalities and the ease of use that today's users experience when utilizing other types of technology such as computers or smartphones.

### SUMMARY

In some embodiments a method for providing answering service via an answering device comprises associating an answering service for a telephone number of a user with the answering device; enabling the answering device to receive at least one call targeted to the telephone number originating from a caller device; starting a call session between the caller device and the answering device; responding to the call by sending to the caller device through the call session an answering message; detecting information related to an alternative communication channel different from the call session; and sending or receiving information via the alternative communication channel.

According to some embodiments, detecting information related to an alternative communication channel includes detecting the type of the caller device and determining the alternative communication channel to be a communication method enabled by the caller device. According to some embodiments, detecting the type of the caller device includes detecting that the caller device is a smartphone and determining the alternative communication channel to be text messaging to the smartphone.

According to some embodiments, detecting information related to an alternative communication channel includes receiving the information related to the alternative communication channel from the caller device.

According to some embodiments, the alternative communication channel is an email address, an alternative telephone number, or a fax number.

According to some embodiments, a method for setting up answering service via an answering device comprises assigning a target telephone number to be serviced by the answering device; and assigning a call path to a call directed to the target telephone number. According to some embodiments, the target telephone number is a first telephone number and wherein the method further comprises assigning a second telephone number to be serviced by the answering device.

According to some embodiments, assigning the call path includes assigning one or more answering messages to the call directed to the target telephone number. According to some embodiments, assigning the call path includes assigning a plurality of answering messages to the call directed to the target telephone number, and wherein each of the plurality of the answering messages is used to answer the call based on a condition. According to some embodiments, the condition includes the date, the time of the day, the status of a business associated with the target telephone number, the origin of the call, or the type of the caller device.

According to some embodiments, the method further comprises assigning a condition for the call to be directed to the answering device. According to some embodiments, the condition includes that the target telephone number does not answer the call after a specified number of rings. According to some embodiments, assigning the call path includes associating an attachment with the mailbox of the target number. According to some embodiments, the method further comprises recording one or more answering voice messages.

According to some embodiments, the method further comprises recording one or more answering voice messages. According to some embodiments, the target telephone number is a first telephone number of a plurality of telephone numbers and the one or more answering voice messages are a plurality of voice messages, and wherein the method further comprises: assigning a second telephone number to be also serviced by the answering device; tying a first of the plurality of answering voice messages as the answering message to the first telephone number; and tying a second of the plurality of answering voice messages as the answering message to the second telephone number.

According to some embodiments, the one or more answering voice messages are a plurality of voice messages, and the method further comprises tying a first of the plurality of answering voice messages as the answering message to the telephone number when a condition is satisfied; and tying a second of the plurality of answering voice messages as the answering message to the telephone number when the condition is not satisfied, wherein the condition includes the date, the time of the day, the status of a business associated with the target telephone number, the origin of the call, or the type of the caller device.

In some embodiments, a telephone answering system comprises an answering device assigned for answering service for a telephone number of a user, wherein the answering device is configured to: receive at least one call targeted to the telephone number originating from a caller device, start a call secession between the caller device and the answering device, respond to the call by sending to the caller device through the call session an answering message, detect information related to an alternative communication channel different from the call session, and sending or receiving information via the alternative communication channel; and an answering server configured to store information related to the call, the answering message, or the information. In some embodiments, the answering device is a desktop computer, a laptop, or a smartphone. In some embodiments, the answering server is a desktop computer, a laptop, or a supercomputer.

In some embodiments a method for providing answering service via an answering device comprises associating an answering service for a target telephone number of a user with the answering device; enabling the answering device to receive a call directed from a caller device to the target telephone number; storing an answering message; and configuring the answering device to send back the answering message to the caller device in response to receiving the call.

According to some embodiments, the method further comprises configuring the answering device to send back the answering message to the caller device in response to receiving the call when a condition is satisfied. According to some embodiments, the condition is based on a date of the call or a time of the day of the call. According to some embodiments, the condition is based on a status of a business associated with the target telephone number. According to some embodiments, the condition is based on an origin of the call or a type of the caller device. According to some embodiments, the condition is satisfied when the call is received at a specific occasion.

According to some embodiments, the answering message is one of a plurality of answering messages, and the method further comprises enabling each answering message of the plurality of answering messages to be sent back to the caller device in response to receiving the call and when a corresponding condition of a plurality of conditions is satisfied. According to some embodiments, each of the plurality of conditions are satisfied at one of a plurality of time ranges. According to some embodiments, the answering message is stored in an answering server.

According to some embodiments, the method further comprises including in the answering message a pre-recorded message selected from a message library. According to some embodiments, the message library includes generic messages configured to be purchased and included in the answering message.

According to some embodiments, the method further comprises receiving, by the answering device, an incoming message delivered by the call; converting, via a converter module, the incoming message to a text message; and transmitting the text message to a recipient device.

According to some embodiments, the recipient device is a display screen, a fax machine, or a smartphone. According to some embodiments, the converter module is included in the answering device. According to some embodiments, the converter module is included in a server device configured to communicate with the answering device.

According to some embodiments, the method further comprises receiving, by the answering device, an incoming message delivered by the call; and storing the incoming message at an internet location accessible via an internet connection. 1 According to some embodiments, the internet location is accessible via a world wide web connection. According to some embodiments, storing the incoming message includes storing one or more of an audio recording of the incoming message and a text rendition of the incoming message.

According to some embodiments, a method for providing answering service via an answering device comprises associating an answering service for a target telephone number of a user with the answering device; enabling the answering device to receive a call directed to the target telephone number originating from a caller device; starting a call session between the caller device and the answering device; responding to the call by sending to the caller device through the call session an answering message; detecting information related to an alternative communication channel different from the call session; and exchanging information via the alternative communication channel.

According to some embodiments, detecting the information related to the alternative communication channel includes detecting a type of the caller device and determining the alternative communication channel to be a communication method enabled by the caller device. According to some embodiments, detecting the type of the caller device includes detecting that the caller device is a smartphone and determining the alternative communication channel to be text messaging to the smartphone. According to some embodiments, detecting the information related to the alternative communication channel includes receiving the information related to the alternative communication channel from the caller device.

According to some embodiments, the alternative communication channel is an email address, an alternative telephone number, or a fax number. According to some embodiments, detecting the information related to the alternative communication channel includes detecting that the caller device has enabled an answering communication interface. According to some embodiments, exchanging information via the answering communication interface does not utilize a telephonic channel. According to some embodiments, exchanging information via the answering communication interface utilizes an internet communication channel.

According to some embodiments, detecting the information related to the alternative communication channel includes detecting that the caller device or a caller with whom the call session is established have previously registered for communication via the alternative communication channel. According to some embodiments, the exchanged information includes one or more of a multi-media document, a music file, a video file, and a text message.

According to some embodiments, a method for setting up answering service via an answering device comprises assigning a target telephone number to be serviced by the answering device; and assigning a call path to a call directed to the target telephone number.

According to some embodiments, the target telephone number is a first telephone number and wherein the method further comprises assigning a second telephone number to be serviced by the answering device. According to some embodiments, assigning the call path includes assigning one or more answering messages to the call directed to the target telephone number. According to some embodiments, assigning the call path includes assigning a plurality of answering messages to the call directed to the target telephone number, and wherein each of the plurality of answering messages is used to answer the call based on a condition.

According to some embodiments, the condition includes a date, a time of the day, a status of a business associated with the target telephone number, an origin of the call, or a type of a caller device.

According to some embodiments, the method further comprises assigning a condition for the call to be directed to the answering device. According to some embodiments, the condition includes that the target telephone number does not answer the call after a specified number of rings. According to some embodiments, assigning the call path includes associating an attachment with a mailbox of the target telephone number.

According to some embodiments, the method further comprises recording one or more answering voice messages. According to some embodiments, the method further comprises recording one or more answering voice messages.

According to some embodiments, the target telephone number is a first telephone number of a plurality of telephone numbers and the one or more answering voice messages are a plurality of answering voice messages, and the method further comprises assigning a second telephone number to be also serviced by the answering device; tying a first of the plurality of answering voice messages as the answering message to the first telephone number; and tying a second of the plurality of answering voice messages as the answering message to the second telephone number.

According to some embodiments, the one or more answering voice messages are a plurality of answering voice messages, and wherein the method further comprises: tying a first of the plurality of answering voice messages as the answering message to the target telephone number when a condition is satisfied; and tying a second of the plurality of answering voice messages as the answering message to the target telephone number when the condition is not satisfied, wherein the condition includes a date, a time of the day, a status of a business associated with the target telephone number, an origin of the call, or a type of a caller device.

In some embodiments, a telephone answering system comprises an answering device assigned for answering service for a telephone number of a user, wherein the answering device is configured to: receive a call directed to the telephone number originating from a caller device, start a call session between the caller device and the answering device, respond to the call by sending to the caller device through the call session an answering message, detect information related to an alternative communication channel different from the call session, and exchanging information via the alternative communication channel; and an answering server configured to store information related to the call, the answering message, or the information.

According to some embodiments, the answering device is a desktop computer, a laptop, or a smartphone. According to some embodiments, the answering server is a desktop computer, a laptop, or a supercomputer.

Some embodiments provide a method for configuring a telephone device as an answering device, wherein the telephone device has a plurality of incoming lines and responds to calls made to a first telephone number through a first incoming line of the plurality of incoming lines. The method comprises configuring a second incoming line of the plurality of incoming lines that is different from the first incoming line to receive a call made to a second telephone number different from the first telephone number; and configuring the answering device to provide an answering service for the second telephone number by answering the call received through the second incoming line.

According to some embodiments, the telephone device is a mobile phone. According to some embodiments, the answering service for the second telephone number includes responding to the call received via the second incoming line by an answering message. According to some embodiments, the answering service for the second telephone number includes forwarding the call received via the second incoming line to the second telephone number. According to some embodiments, the telephone device is a first telephone device and wherein a second telephone device is associated with the second telephone number, the method further comprising configuring the second telephone device to redirect to the second incoming line of the first telephone device calls made to the second telephone number. According to some embodiments, one of the first and the second telephone numbers is associated with a business phone number of a user and the other one is associated with a personal phone number of the user.

According to some embodiments, the first incoming line is serviced by a first telephone service carrier and the second incoming line is serviced by a second telephone service carrier that is different from the first telephone service carrier. According to some embodiments, detecting the information related to the alternative communication channel includes recording an incoming message received from an answering server, wherein the answering server enables a user of a website to leave the incoming message through the website.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1 shows an answering system according to some embodiments.

FIG. 2 shows a flowchart for a system setup method according to some embodiments.

FIG. 3 shows a home screen display for an answering service according to an embodiment.

FIG. 4 shows a settings display for an answering service according to an embodiment.

FIG. 5 shows a recording display for an answering service according to an embodiment.

FIG. 6 shows a flowchart for a call flow according to some embodiments.

FIG. 7 shows a flowchart for a number set up method according to some embodiments.

FIG. 8 shows a caller device interface interaction method according to an embodiment.

FIG. 9 shows an example of multi-media files received by a caller according to an embodiment.

FIG. 10 shows a flowchart for a method of customizing answering messages according to some embodiments.

FIGS. 11A and 11B show screens related to a media library according to some embodiments.

FIG. 12 shows a schedule setting interface according to one embodiment.

FIG. 13 shows a prompt configuration screen according an embodiment.

FIG. 14 shows an attachment provision screen according an embodiment.

FIG. 15 shows a flowchart for a conversion according to some embodiments.

FIG. 16 shows an inbox interface for reviewing and converting incoming messages according to one embodiment.

FIG. 17 shows a transcription window according to an embodiment.

FIG. 18 shows an answering service dashboard according to an embodiment.

FIG. 19 shows a flowchart for configuring a telephone device as an answering device according to some embodiments.

### DETAILED DESCRIPTION

The following detailed description refers to the accompanying drawings. Wherever possible, the same or similar reference numbers are used in the drawings or in the description to refer to the same or similar parts. Also, similarly-named elements may perform similar functions and may be similarly designed, unless specified otherwise. Numerous details are set forth to provide an understanding of the described embodiments. The embodiments may be practiced without these details. In other instances, well-known methods, procedures, and components have not been described in detail to avoid obscuring the described embodiments.

While several exemplary embodiments and features are described here, modifications, adaptations, and other implementations may be possible, without departing from the spirit and scope of the embodiment. Accordingly, unless explicitly stated otherwise, the descriptions relate to one or more embodiments and should not be construed to limit the embodiment as a whole. This is true regardless of whether or not the disclosure states that a feature is related to “one,” “one or more,” “some,” or “various” embodiments. Instead, the proper scope of the embodiment is defined by the appended claims. Further, stating that a feature may exist indicates that the feature exists in one or more embodiments.

In this disclosure, the terms “include,” “comprise,” “contain,” and “have,” when used after a set or a system, mean an open inclusion and do not exclude addition of other, non-enumerated, members to the set or to the system. Moreover, as used in this disclosure, a subset of a set can include one or more than one, including all, members of the set.

Various embodiments include an answering system that addresses the aforementioned problems of existing answering services and further adds several beneficial features, such a bi-directional communication between a caller and a receiver of the call.

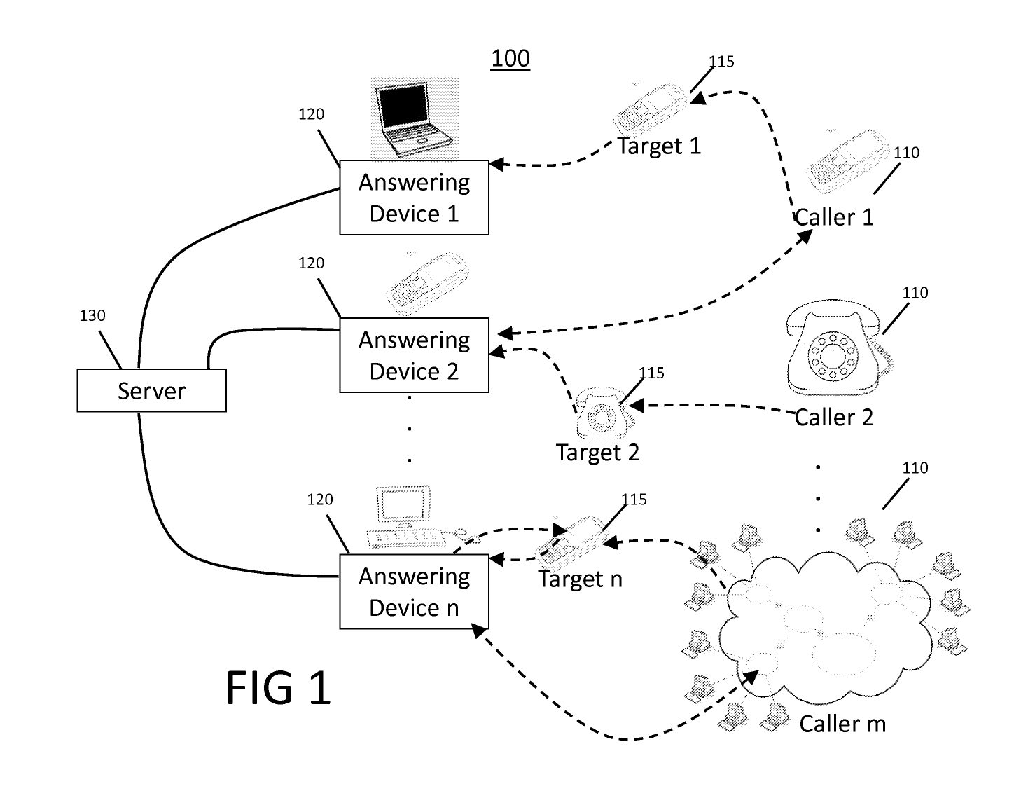

FIG. 1 shows such an answering system 100 according to some embodiments. System 100 includes one or more caller devices 110 (labeled in FIG. 1 as caller 1 to caller m), one or more target devices 115 (labeled in FIG. 1 as target 1 to target n), one or more answering devices 120 (labeled in FIG. 1 as answering device 1 to answering device n), and an answering server 130.

Caller device 110 is a device that a caller uses for calling a target number, such as a user's phone number. Upon doing so the call may first be directed to a target device 115 associated with the target number, and a call session may be established between the caller device and a target device. Target device 115 may be, for example, the user's home phone or business phone. The user may have set up the answering system such that, after a specific event, the call is redirected from the user's target device to the user's answering device. The specific event may include that, for example, the target device rings for a pre-specified number of times and is not picked up. Alternatively, in some cases, the user may set up the answering system such that after the caller calls the target number, the call is immediately redirected to the answering device. Upon this event, a call session may establish between the caller device and the answering device. In various embodiments, the caller device may be a mobile phone using a wireless connection, a landline phone using a landline connection, or a VOIP dialer using an internet connection.

In some embodiments, each answering device 120 may provide a telephone answering service for one or more target numbers of one or more users. A user may set up answering device 120 to act as an answering machine for one or more of the phone numbers used by the user. The user, for example, may set up a smartphone or a laptop to answer incoming calls to the user's personal phone number and one or more business phone numbers. In some embodiments, answering device 120 may be a mobile device, a landline phone, or a computer such as a laptop or a desktop. In some embodiments, answering device 120 may include one or more processors performing the processes detailed herein. In various embodiments, the processors perform one or more software modules to implement the processes. In some embodiments, answering device 120 may be a smartphone executing a mobile application (“app”) that performs the processes described herein.

In some embodiments, the connection between the caller device and the answering device is bidirectional. That is, the caller's connection to the answering device may trigger receiving some follow up information or documents from then answering device. In some embodiments, the target device and the answer device are both included in the same device. For example, in some embodiments, the caller calls the user's smartphone and is redirected to the answering service, also performed by the same smartphone. The user may set up the answering service of the user's smartphone to answer to calls made to the smartphone as well as calls made to one or more other phones.

In some embodiments, the answering system is set up such that when a caller calls the target device, the call is first directed to the answering device. The answering device may then redirect it to the target device. Alternatively, the answering device may direct the call to a voicemail. This could happen when, for example, a business target has set up the answering service such that during the closed hours of the business the callers are directed to the voicemail without any rings. In some embodiments, the target device is configured such that when it receives a call, it redirects the call to the answering device.

Answering server 130 interacts with one or more answering devices 120. In particular, server 130 includes a database for storing information related to the answering service provided by answering devices 120. In various embodiments, server 130 may include a computer, such as laptop or a desktop, a specialized processor, a multi-processor, or a network of one or more processors. Moreover, server 130 may include one or more data storage systems, databases, and communication interfaces for performing the functions detailed herein. The server may maintain a backup copy of data stored on one or more answering devices; store voicemails or other information related to calls received by one or more answering devices; provide supplemental storage to the answering devices, for storing incoming voicemail and messages, or answering messages for future re-use; communicate text messages from customers; and manage communications between different devices such as answering devices and caller devices.

In some embodiments, answering server 130 may include one or more processors performing the processes detailed herein. In various embodiments, the processors perform one or more software modules to implement the processes performed by the server.

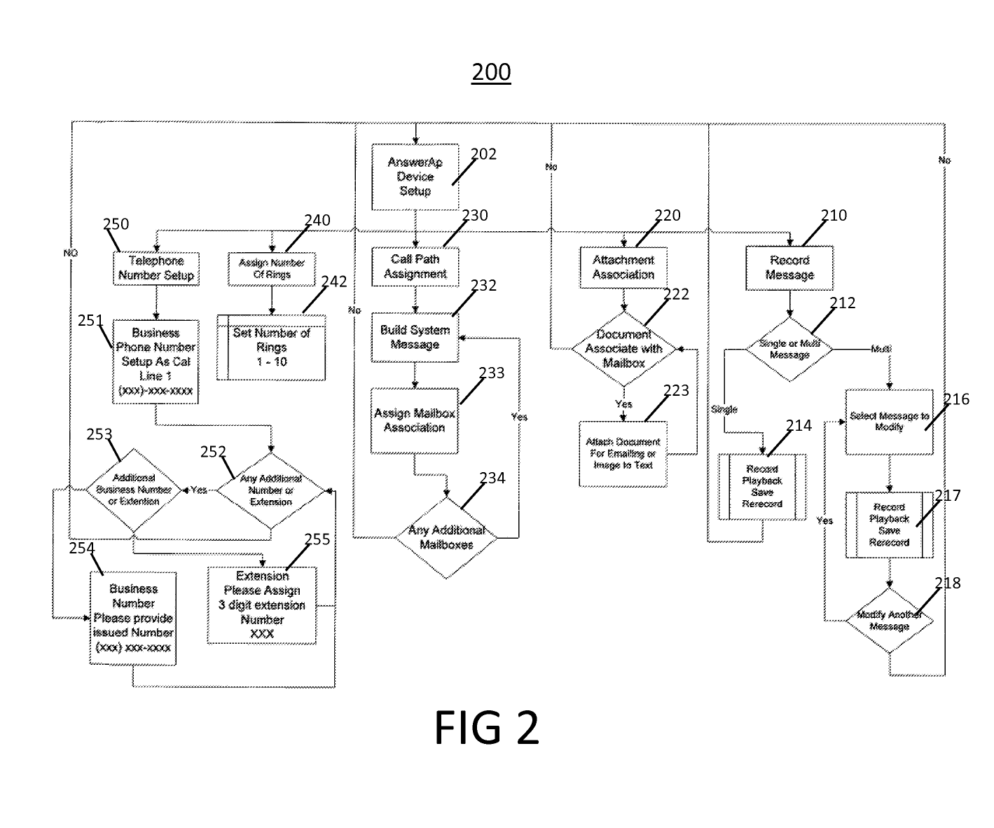

FIG. 2 shows a flowchart for a system setup method 200 according to some embodiments. A user may perform method 200 in interaction with an answering device. Method 200 includes setting up an answering service by the answering device for one or more of the user's phone numbers. In some of the shown embodiments, such as the one in FIG. 2, the answering service is called AnswerApp.

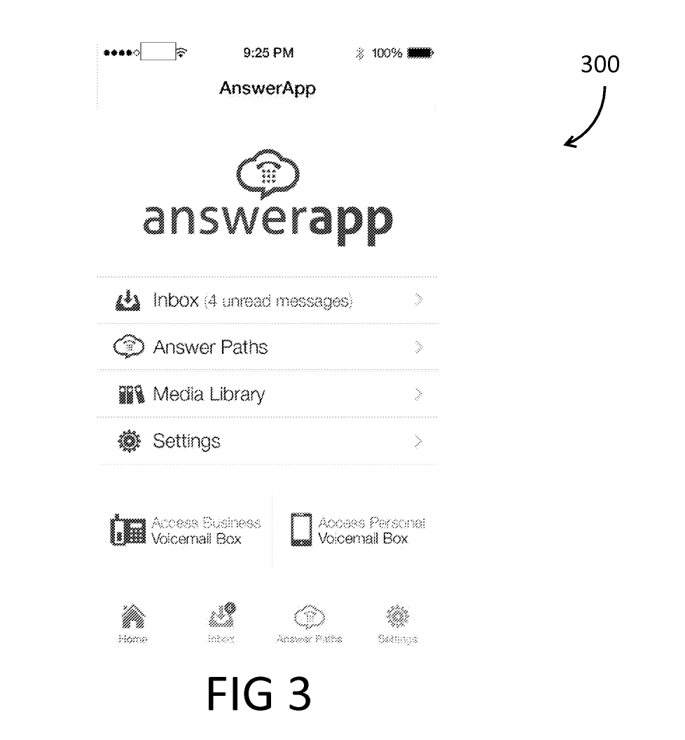

FIG. 3 shows a home screen display 300 for an AnswerApp answering service according to an embodiment. Home screen 300 allows the user to access the user's incoming messages in the Inbox; set up answer paths or call paths, as detailed below; access media library, detailed below; and define some settings of the answering device. Home screen 300 further allows the user to access voicemails in two of the user's voicemail boxes, here related to the user's business and personal phone numbers. In some embodiments, home screen display 300 is the first screen that the user receives when the user opens an answering service application on a computer or on a mobile phone.

Returning to setup method 200 of FIG. 2, in block 202 the user selects an option for setting up the device. The answering device may present to the user one or more different setup options. These setup options may include recording one or more messages (210), attachment association (220), call path assignment (230), assign number of rings (240), and telephone number setup (250).

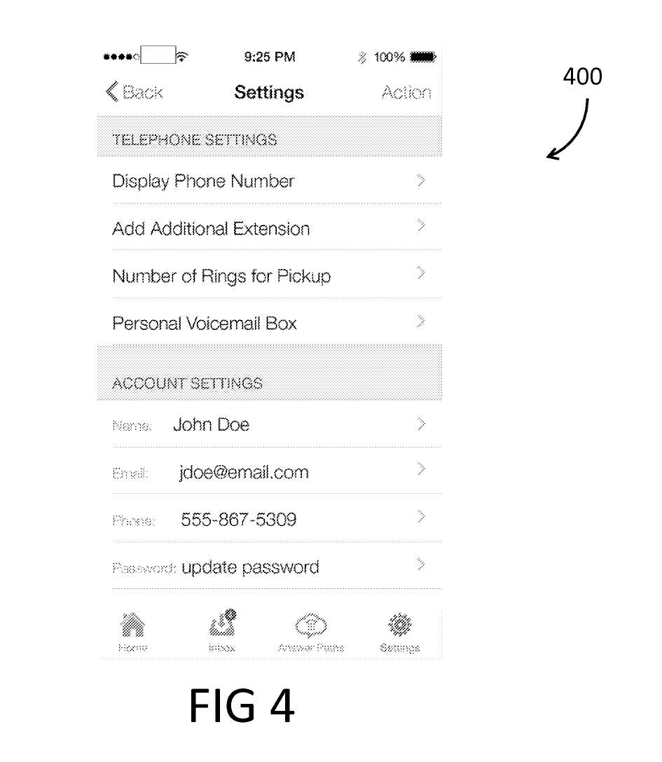

FIG. 4 shows a settings display 400 for an answering service according to an embodiment. Settings display 400 provides to the user options for viewing and modifying telephone settings and account settings. In particular, telephone settings include options related to displaying phone number, adding more extensions, number of rings for pickup, and personal voicemail box.

Returning to block 210 of FIG. 2 for recording one or more messages, in decision block 212 the device inquires whether the user wants to record and playback a single message or multiple messages for the answering service. If the user selects a single message, in block 214 the user can record and store the message. In various embodiments, the message may be stored on the answering device or on the server. Similarly, if the user selects multiple messages, the user can record and store those multiple messages. In some embodiments, the user may also modify existing messages. For example, in blocks 216-218, the user selects one or more messages and modifies them. In some embodiments, the user modifies a message by replacing it with a new message. In some embodiments, a user modifies a message by clipping some sections of it or by appending to it parts of another recorded message. For example, a user may record a general greeting related to the business or to an occasion and append it to the beginning of several answering messages for different departments or extensions.

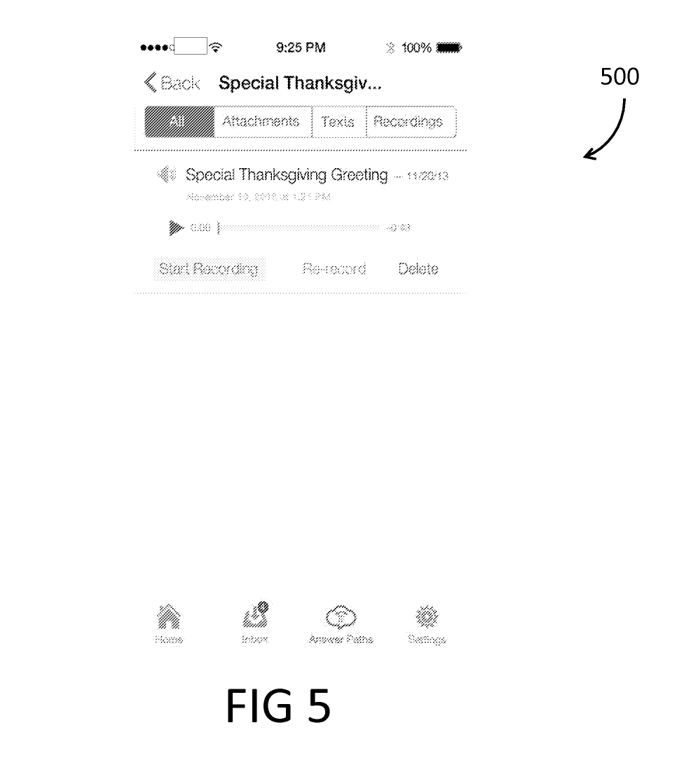

FIG. 5 shows a recording display 500 for an answering service according to an embodiment. Recording display 500 provides to the user options for recording, re-recording, and deleting an answering voice message. Moreover, the system allows the user to tie the voice message to a special occasion, date, range of dates, or times of day. In FIG. 5, for example, the voice message relates and is tied to the Thanksgiving Day. The user, thus, can set up the system to use this message on the Thanksgiving Day.

Returning to block 220 of FIG. 2 for attachment association, in blocks 222 and 223, the user can associate a document with a mailbox. The document may be a multi-media document, such as an audio file, an image file, or a video file. The document may also be a text file or another type of file. The user may assign one or more such documents to be sent to a caller in the manner detailed below.

Regarding block 230 for call path assignment, in blocks 232-234, the device builds system messages and assigns them to one or more mailboxes set up in the answering device. An answering device may service more than one mailbox. Each mailbox may correspond to, for example, one of the phone numbers serviced by the answering device.

If the user chooses to assign the number of rings (block 240), in block 242 the device may set that number based on an input from the user. This number may determine how many times the target device should ring before the call is redirected to the answering service.

If the user chooses to set up telephone numbers for the one or more mailboxes (block 250), in blocks 251-255 the system receives and sets one or more phone numbers or extension numbers. The system may further associate those numbers or extensions with one or more mailboxes or call paths, as detailed below.

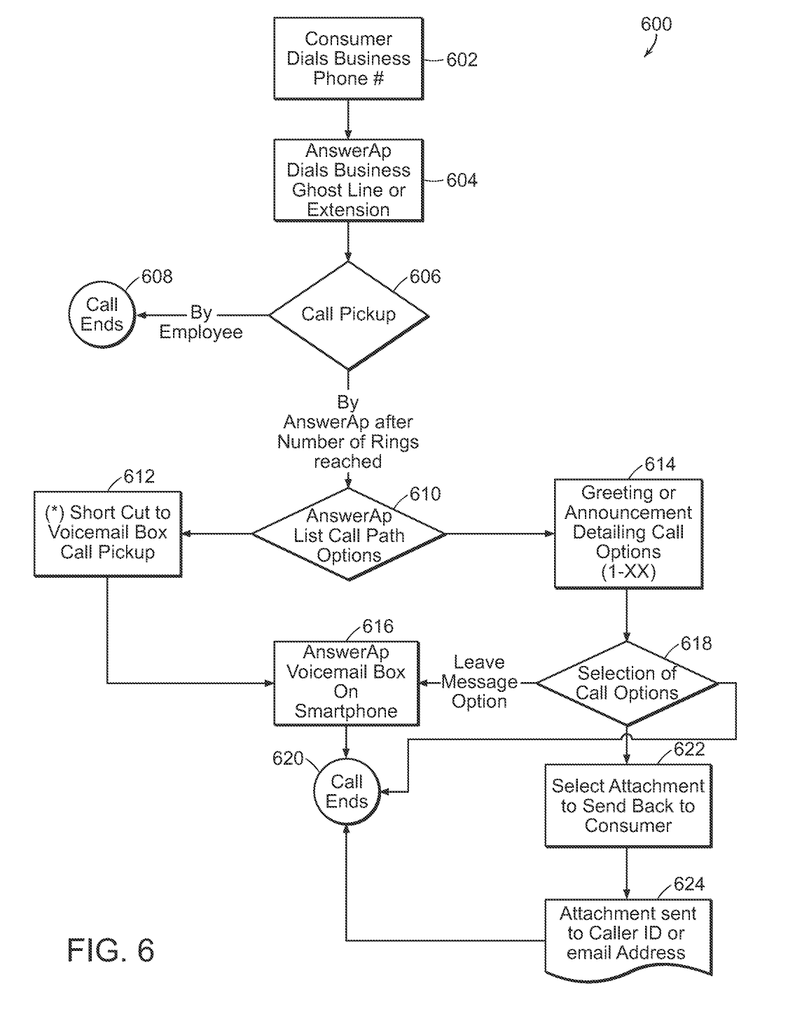

In various embodiments, the system sets one or more call flows for calls received by one or more target devices and directed to the answering device. FIG. 6 shows a flowchart for a call flow 600 according to some embodiments. Call flow 600 defines a set of steps taken for a call that a business number receives. Call flow 600 may apply to calls made to a specific target device or during specific times.

In block 602, the caller dials the phone number of the business. In the embodiment shown, the call is first directed to the answering device. In block 604, the answering device receives the identification of the target number from the call and dials the ghost line or extension associated with the target number.

In decision block 606, the system determines whether the target device is picked up within the designated time or number of rings. If it is picked up (block 608), the call flow ends.

If, on the other hand, the target device is not picked up, a call session starts between the answering device and the caller device. The call session includes a set of interactions between the answering device and the caller device thorough the telephone channel. In decision block 610, the answering device may choose one of multiple possible call paths at this junction. Each call path includes a set of steps taken by the answering device. These steps may include, for example, a shortcut to the voicemail box or listening to the greeting and further options. In some embodiments, the answering device presents these options to the caller and allows the caller to select one by, for example, pressing a button or stating an option. In some embodiment, the call path is selected by the system based on one or more conditions, such as the time of the day, the date (such as specific holidays), or the state of a business (for example, when a restaurant is at full capacity and cannot accept patrons).

If, for example, the shortcut option is selected (block 612), the caller is directed to the voicemail box (block 616), and the call ends after the caller leaves a voicemail (block 620). If, on the other hand, the greeting option is selected, in block 614 the answering device plays for the caller a greeting message. The greeting message, itself, may change based on the target number or extension, date or time, or state of the business, or other conditions. The greeting may also end by letting the caller choose one or more options by pressing one or more keys.

In decision block 618, the system determines the next step based on the selection of the caller. The caller may, for example, select leaving a voicemail (block 616), ending the call by selecting a corresponding option or simply hanging up (620).

The caller may also select receiving some additional information in the form of, for example, a text, a URL, a voice message, a display, or an attachment (block 622). In some cases, for example, the answering service of a business may offer that the caller receive a brochure, menu list, or program list of the business.

The service may further ask the caller to provide a means for receiving the additional information. The caller may, for example, select receiving the information or documents via audio message played back to the caller, a fax sent back to the caller's fax machine, a document emailed back to the user's email address, a display message or document sent to the user's email address or smartphone, or a text message sent to the user's smartphone or other devices.

The caller may further provide the details of the connection for the means, such as, the email address, smartphone number, or fax number. The caller may provide this information by voicing it in the system. The system may then use a voice recognition technique to interpret that information and use it. Alternatively, the caller may enter this information using the phone's keypad, or more advanced entry options if the caller is using, for example, a smartphone. As part of the interaction, the answering device may ask the caller to identify the type of the caller device (such as traditional phone, smartphone, or VOIP dialer) to accordingly send and receive information in a compatible format (e.g., voice for traditional phone or VOIP phone, or text message for a smartphone). In some embodiments, the answering service detects some of this information, such as the type of the caller device, independent of an input from the caller and transmits the information in accordance with the type. For example, the answering service may detect that the caller device is a smartphone.

In block 624, the system uses the above information to send the caller the additional information via the means that the caller provided. For example, after the answering service detects that the caller device is a smartphone, it may send back the information via a text message that the smartphone can display to the caller.

In some embodiments, the user can set up for the answering system to associate one or more attachments with one or more of the answering messages. A user may, for example, associate a menu document with an answering message to calls made to the user's restaurant. Or a user may associate a program list with an answering message to calls made to the user's music club. The answering message may propose the attachment to the caller and, if the caller requests it, send the attachment to the caller via one or more of the mechanisms detailed above. These mechanisms may include emailing, faxing, or texting the document or information in the attachment.

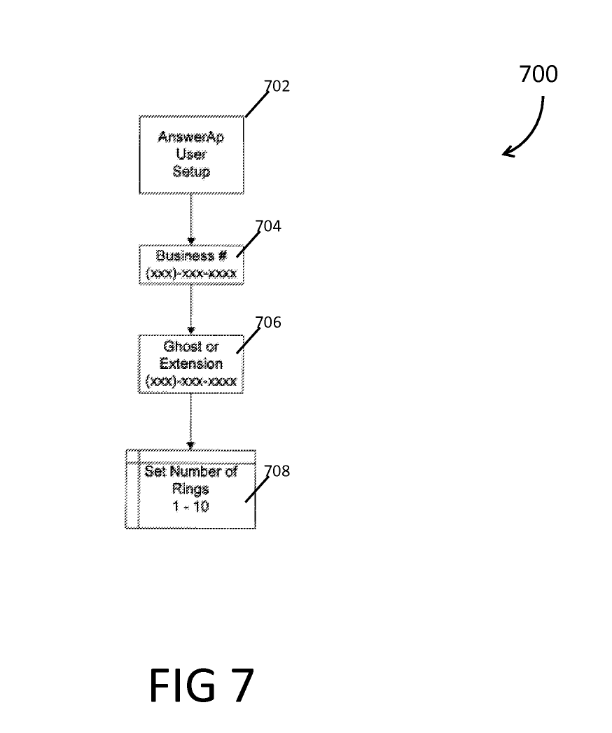

In various embodiments, the system associates one or more target numbers with a call flow. FIG. 7 shows a flowchart for a number set up method 700 according to some embodiments.

In block 702, the user selects setting up the numbers from the setup menu. In block 704, the system receives, for example, a business phone number. In block 706, the system receives a ghost or an extension number. In block 706, the system sets a number of rings for the target number. In some embodiments, the user enters the business number, ghost or extension number, or the number of rings, during the setup process.

Some embodiments further provide an answering communication interface to facilitate the interaction between the caller device and the answering device. In various embodiments, the answering communication interface includes a caller device interface installed on the caller device. A caller may use such an interface to send back different types of information to the answering device. In various embodiments, the interface enables information exchange, that is, transmission of information or messages from the answering device to the calling device, from the calling device to the answering device, or both.

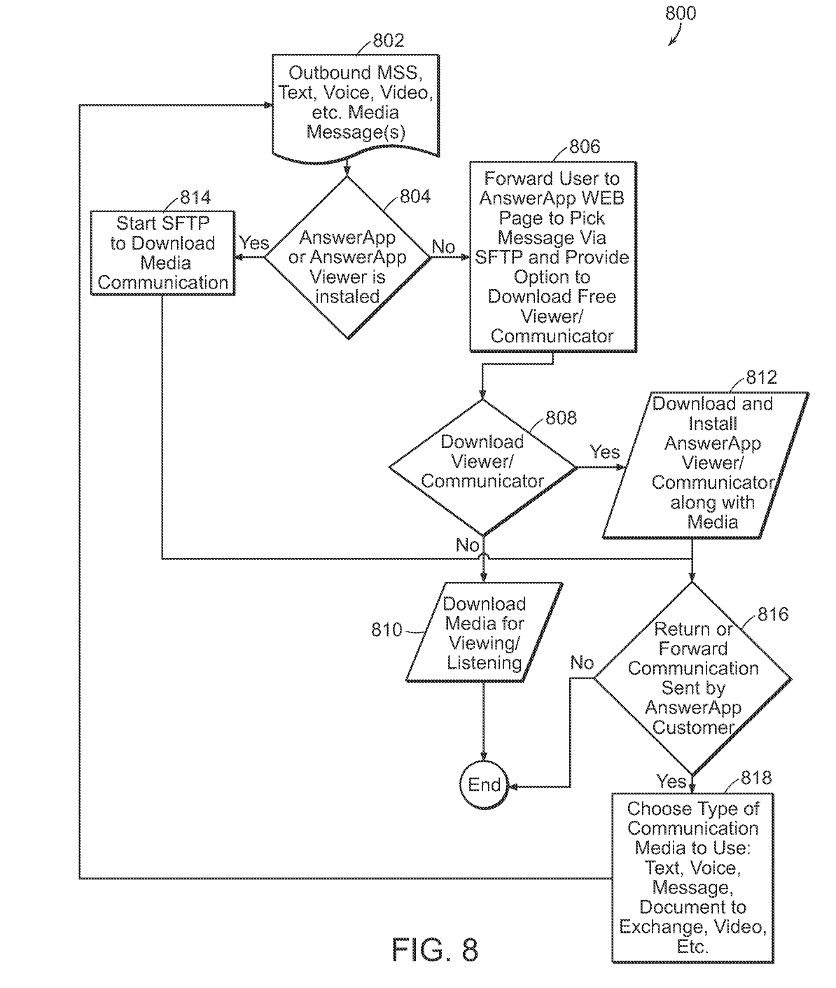

FIG. 8 shows a flowchart for a method 800 through which the answering device interacts with a caller device interface according to an embodiment. In the embodiment shown in FIG. 8, the caller device interface is called the AnswerApp viewer. In some embodiments, the caller device interface is a smartphone or a computer equipped with an application for interacting with the answering device in the manner detailed below.

In block 802, the answering device prepares outbound information to be sent to the caller device. In various embodiment, this information may include, for example a text message, an MSS message, a voice message, a video clip, another type of a media file, or a document.

In block 804, the system determines whether AnswerApp viewer is installed on the caller device. The system may do so by directly asking the caller, by checking the configuration of the caller device, by checking a database of known users, or by checking the installed hardware or software on the caller device.

If the viewer is not installed on the caller device, in block 806 the answering device sends the caller device a means for the caller to install the viewer. This means may include a web link to a webpage associated with the viewer, an FTP site, or an attachment including a light version of the executable for the viewer.

In decision block 808, the system asks the caller whether the caller wishes to install the viewer. If the caller does not wish to do so (block 810), the system may send the information via means that are the caller device without a viewer (such as voice or video for a smartphone) and may then end the process.

If, on the other hand, the caller elects installing the viewer, in block 812 the caller device receives and installs the viewer. Once the caller device is enabled with the viewer for the first time, or if it already installed (block 814), the caller may use the viewer to receive and view the information sent by the answering device.

Moreover, the answering system may ask the caller whether the caller intends to send back to the answering device any information (block 816). If so, in block 818, the caller selects the type of that information, e.g., text, voice, document, video, and sends it to the answering device. In some embodiments, such information is exchanged directly between the caller device interface and the answering device, or between the caller device interface and a corresponding interface installed on the answering device. The viewer may use an internet connection for the exchange. This exchange may thus proceed without using a telephone communication channel between the two devices.

In some embodiments, the caller may send a message to an answering machine using an internet interface. A user that owns a business, for example, may include on the website of the business a link to a system or software that implements a message service on the user's answering server. A caller may be able to visit the website, select the service, and leave a voice message. The answering server records the message and transmits it to the user's answering device. A caller may thus leave a message without the use of a calling device.

Some embodiments enable a text messaging feature. If activated, this feature allows an attachment, such as a brochure, to be sent to a caller by having the caller press a designated key stated in the recorded message. The embodiment allows a user to have a multitude of prompts for different documents including, but not limited to, business schedules, brochures, price lists, menus, wedding announcements, or photos.

In some embodiments, the system detects the type of the caller device and accordingly provides options that fit the capabilities of the caller device. The system may, for example, detect that the caller device is a wireless device or a smartphone, and thus provide options that include exchanging text message or media files that such smartphones can handle. Alternatively, the system may detect that the caller device is not a wireless device and instead present options that does not include those options, but still include exchanging voice messages or fax number via voice.

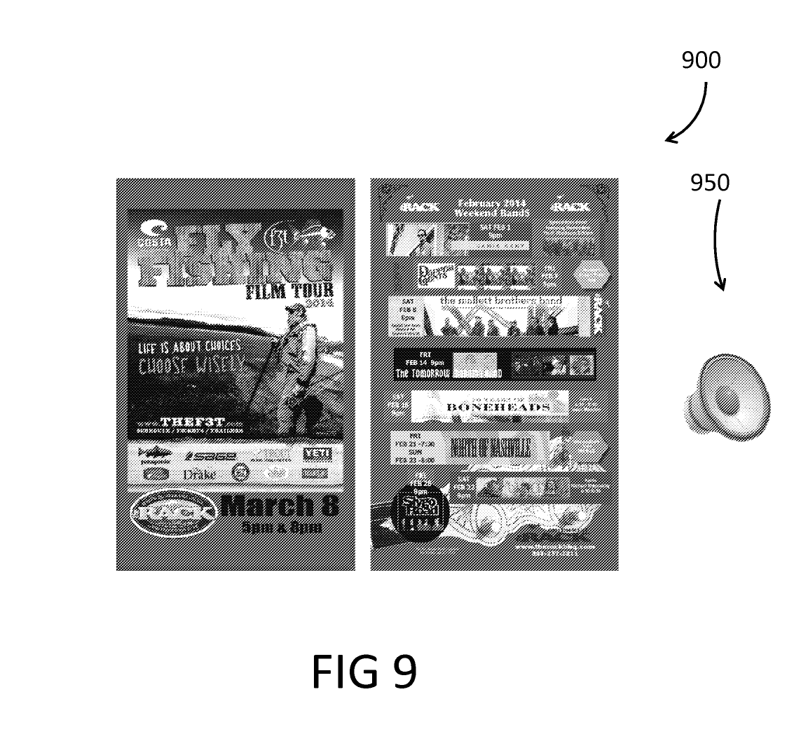

FIG. 9 shows an example of multi-media files 900 and 950 that a caller may receive on the caller's device using the caller device interface according to an embodiment. Alternatively, the caller may be prompted to push a button or state a choice to receive the multi-media files and, if done so, the system will forward the files to the caller's device.

Visual file 900 shows a schedule and offerings of a business on different dates. Audio file 950, on the other hand, may include audio samples of an offered program. Upon reviewing the files, a caller may subsequently choose an offered program and book that program by calling back the business's number, and speaking to a business representative or leaving a message on the answering device. Alternatively, a caller may leave a voice message on the business's answering device using the caller device interface.

In some embodiments, the viewer directly interacts with the answering device without a need for the caller to call back. The caller may thus record a voicemail or draft a text message, requesting a reservation, and send that to the answering device via the viewer. The business can thus receive that message via the answering device and accordingly make the reservation for the caller and possibly send back a response, confirming the reservation.

Several embodiments provide on board smartphone application (“app”), which enables the smartphone to function as an answering machine for a business user or an individual user. In some embodiments, the app is called an AnswerApp. In some embodiments, when a caller calls one of the user's one or more phone numbers, the incoming call may be routed through the smartphone running the app. The smartphone receives the call and transfers it to a line that calls the corresponding target, e.g., the user's home or business. The phone rings at the target for a designated number of rings and, if not picked up, the smartphone transfers the caller to an answering system related to the target phone, in the manner explained.

The AnswerApp technology, that is, an answering device equipped with the AnswerApp application, may require the business or individual user to have two telecommunication lines. The phone number which individuals call to reach a user is entered into the AnswerApp user option field named “enter incoming number,” the user then enters the line 2 into the user option field named “enter outgoing number”.

By using two-line concurrent mobile technology, where two numbers can be received on a smartphone, AnswerApp may receive the call and then dial a ghost or additional phone number, or VOIP or other, which rings the business's or individual's number. The business or individual user sets the desired number of rings to ring at the place of business or home. If there is no answer, AnswerApp picks up the call and takes over as the answering machine, which allows the calling party to activate or use the features described herein.

To record an outgoing message using AnswerApp, a user opens the application and chooses “record out going message or greeting,” presses record, and then either saves, or discards and re-records the outgoing message. The user can record greetings or announcements for multiple days and set each greeting or message to activate at a specified date and time.

After the user prescribed number of rings, the answering machine greeting is activated, without the carrier intervention of message statements that can't be turned off.

AnswerApp may be located on the user's smartphone and no number is required to call in to an LEC. AnswerApp may allow the addition of short cuts that circumvent announcements and allows a caller to go directly to leave a message. AnswerApp may allow as many voice messages as the smartphone has memory for, virtually eliminating the problem of having a full voice mailbox. AnswerApp allows voice messages to be translated to print and to be forwarded via SMS or e-mail, or to be printed out. AnswerApp user options are streamlined allowing a user to record a message without having to dial into a system or be annoyed by numerous prompts. AnswerApp simplifies and gives immediate access for a user to record and update an outgoing message from anywhere in the world. AnswerApp allows a user to add one or more extensions.

AnswerApp also allows a user to cut and paste portions of, or all of, a previously recorded message to other extensions to create or modify outgoing messages for those extensions. AnswerApp allows a user the option to edit a recorded message and add music, using editing tools which would allow for layering music over the recorder's voice, or fade in and fade out, as well as standard equalizer controls and volume levels a standard recording program might have.

Additional technology allows for text messaging. If activated, this feature allows an attachment, such as a brochure, to be sent to a caller by having the caller press a designated key stated in the recorded message. The app allows a user to have a multitude of prompts for different documents including, but not limited to, band schedules, brochures, price lists, menus, wedding announcements, or photos.

AnswerApp allows a user access to a list of callers, and to the data associated with incoming messages; such as caller ID, time and duration. AnswerApp will display on the smartphone icon how many messages are stored in the answering machine. AnswerApp user options allow a user to add ring tones to incoming messages and individual phone numbers.

AnswerApp can be set to “automatic pickup” instead of ringing the business. For larger businesses AnswerApp will allow a caller to hear an automated announcement and choose.

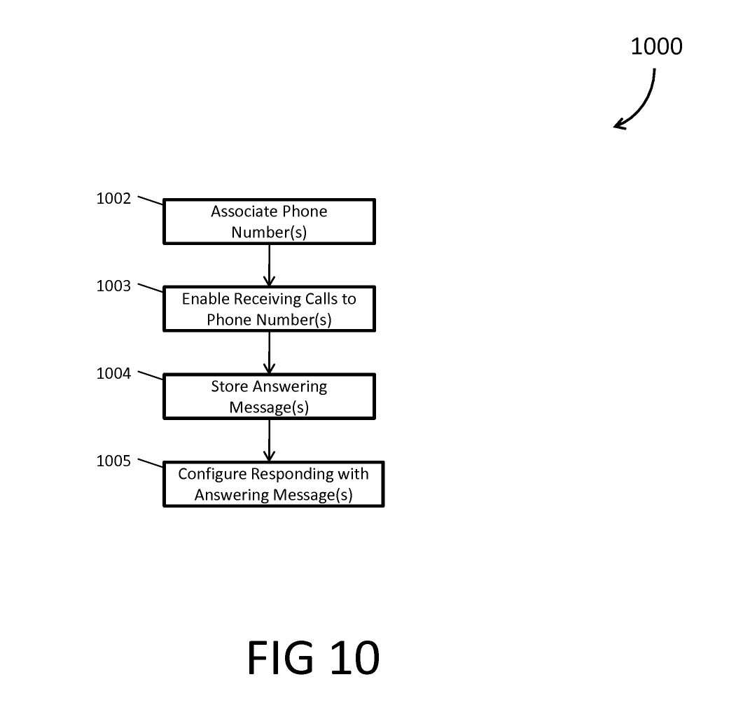

In some embodiments, the system enables customizing one or more answering messages to be used for different telephone numbers or under different conditions. FIG. 10 shows a flowchart for a method 1000 of customizing answering messages according to some embodiments. In particular, method 1000 includes blocks 1002-1005 to configure an answering device for providing answering service by responding to incoming calls via one or more answering messages. In various embodiments, one or more users can configure an answering device based on steps shown in blocks 1002-1005.

In block 1002, a user associates with the answering device a telephone number as a target telephone number. In some embodiments, such association means that the answering device will provide answering service to the target telephone number in the manner detailed here. In some embodiments, the answering device is associated with more than one telephone number and provides answering service to those multiple numbers.

The answering device may be, for example, the personal telephone of a user. This telephone may be configured to answer the calls that are made not only to the telephone's phone number, i.e., to the user's personal phone number, but also to a different phone number that is the user's business phone number. In some embodiments, the answering device answers the calls made to different phone numbers in different ways, as detailed here.

In block 1003, the system enables the answering device to receive calls that are directed to the one or more target phone numbers. Such enabling may include that such calls are redirected to the answering service of the answering device. The redirection may occur after a connection is established between the calling device and the target device, or after the target device rings a number of times and no one picks up. In some embodiments, the target device may be the same as the answering device.

In block 1004, the system stores an answering message. The answering message may be an audio message that a user selects from a set of one or more a pre-recorded messages, or an audio message that the user records via the answering device. In some embodiments, the user may select a pre-recorded message from a library of messages. The library may include an audio message recorded by a celebrity. Further, the library may allow the user select such messages in return for a charge.

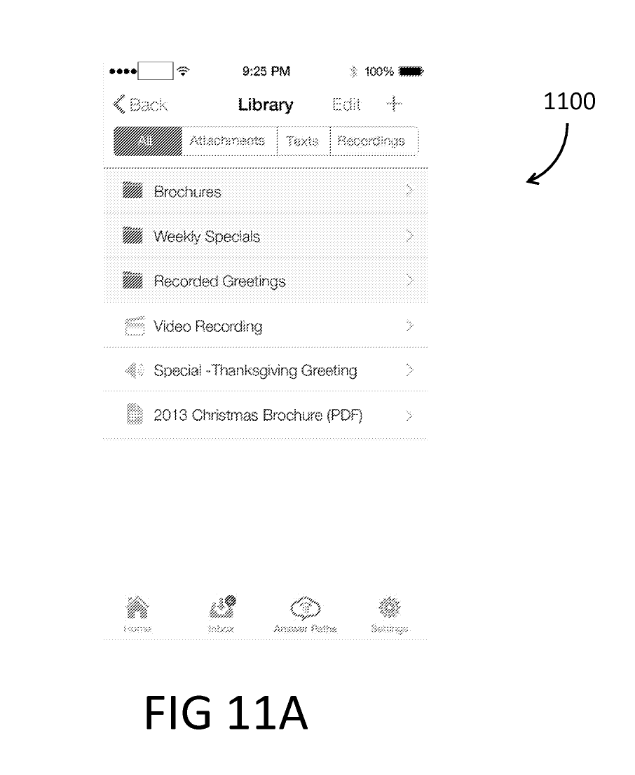

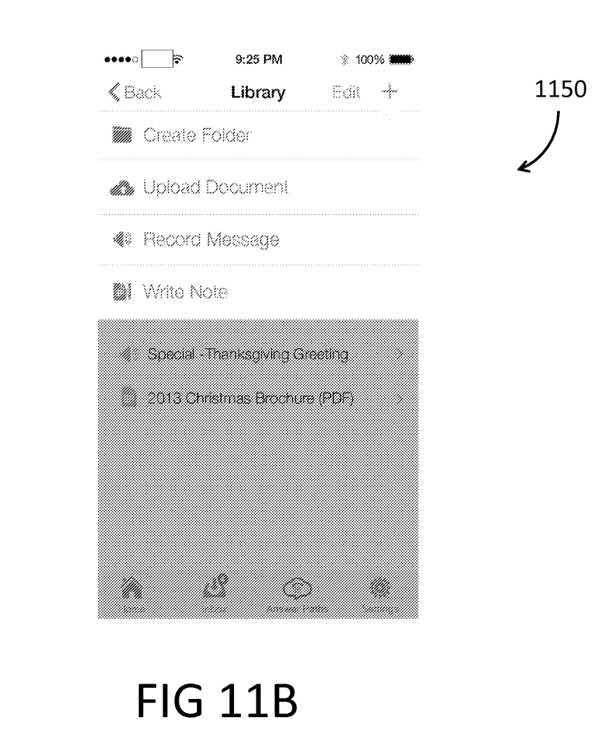

FIGS. 11A and 11B show screens related to a media library according to some embodiments. The media library may enable a user to create, store, organize, and select from a set of multimedia files.

In particular, FIG. 11A shows a library home screen 1100, which presents to a user information and options for selecting different types of materials for transferring to a caller. Screen 1100 enables a user to select files, including audio or video files. Some of these files may be associated with a special occasion, such as the Thanksgiving holiday.

FIG. 11B, on the other hand, shows an add item screen 1150, which allows a user to add items to a library. Screen 1150 includes options for adding a folder, e.g., associated with a special occasion. Screen 1150 also includes options for uploading a document and recording a message. A user can use items in the library for answering to an incoming call or for attachment to an outgoing message.

In some embodiments, a user may record or select more than one answering message and store them for answering to calls made to one or more associated phone numbers. In various embodiments, the answering messages may be stored in an answering device or in an answering server.

Returning to FIG. 10, in block 1005 the answering device is configured to respond to an incoming call with the one or more answering messages. The answering device may be configured to respond to calls that are directed to different associated numbers with the same answering message or with different answering messages. Different answering messages may, for example, be recorded by different people or make different statements, each related to a specific phone number. For example, the answering message for a personal phone number may identify the person who has been reached, while the answering message for a business phone number may identify the business, its services, or its schedule.

In some embodiments, the system also associates one or more conditions for using an answering message. Thus an answering message may be associated not only with one or more of the target phone numbers but also with one or more conditions. The conditions may include, for example, a temporal condition. A user may record different answering messages for the user's business each customized for one or more days of the week. For example, the user may record a first message for Monday, a second message for Tuesday and Wednesday, and so on. The system can set conditions for the first message to be used in answering calls that arrive on Monday and for the second message to be used for calls that arrive on Tuesday or on Wednesday, and so on. The conditions may further include one or more of a time of the day, e.g., during or after operating hours; specific occasions, e.g., holidays; or special events, e.g., promotions or concerts at the corresponding business. One such embodiment is shown in FIG. 5 above, in which a greeting is recorded and it is set to be used on a Thanksgiving holiday.

Also, some conditions may relate to the origin of the incoming call. For example, the answering system may detect the type of the calling device or its capabilities, and accordingly use an answering message that corresponds to those capabilities. The answering message, for example, may offer sending to the calling device a text message or a multi-media file, if the calling device can receive such items. Alternatively, the user may record an answering message for one or more specific callers. The condition for the message may then include that the call originates from those callers, whom the answering device may identify by their caller identifiers.

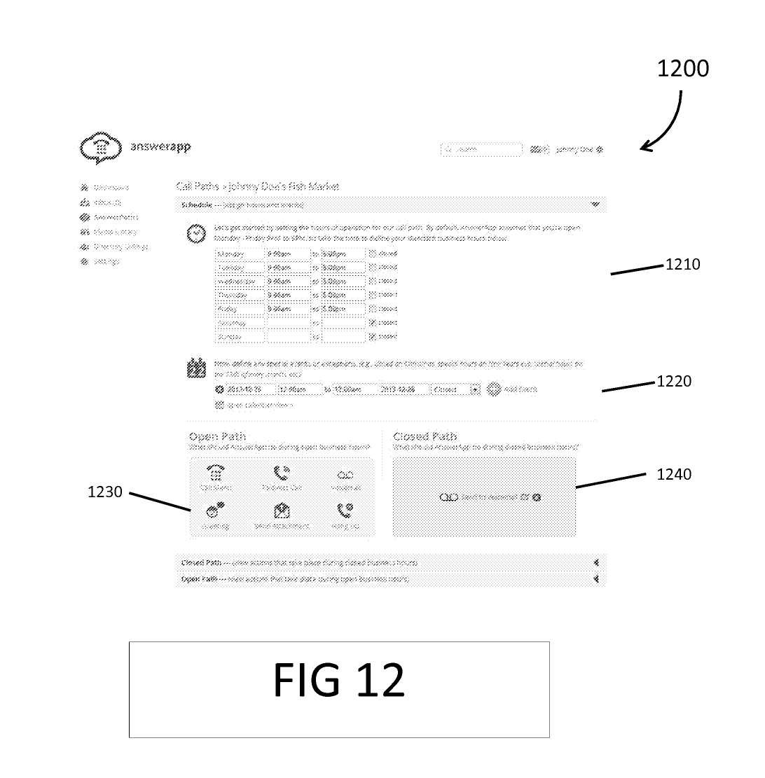

In some embodiments, the answering system enables a user to define a condition and associate with the condition one or more answering messages. To that end, the system may provide to the user one or more interactive interfaces or form interfaces. FIG. 12 shows a schedule setting interface 1200 that enables defining temporal conditions according to one embodiment. A user may use interface 1200 to define for a business call paths, i.e., processes for different incoming calls.

Interface 1200 includes an operation hours setting section 1210, a special event setting section 1220, an open path section 1230, and a closed path section 1240.

Operation hours setting section 1210 enables the user to enter hours of operation of the business on each day of the week. Special events section 1220 enables the user to enter date or time of special events, such as holidays, and whether the business is open or closed during those events.

Open path section 1230 enables the user to define one or more call paths for calls that are received at a time that the business is open. Close path section 1240, on the other hand, enables the user to define one or more call paths for calls that are received at times that the business is closed. In particular, each of the sections 1230 and 1240 may enable the user to configure the answering device to respond to an incoming call by one or more response actions. A response action may include redirecting the call, sending the call to a voicemail receiver, playing a greeting message, sending an attachment, or terminating the call. In some embodiments, the answering device may be configured to choose a response action from a group of response actions based on characteristics of the incoming call, such as its time, origin, or contents, e.g., when the caller selects an option by pressing a key and in response to a prompt.

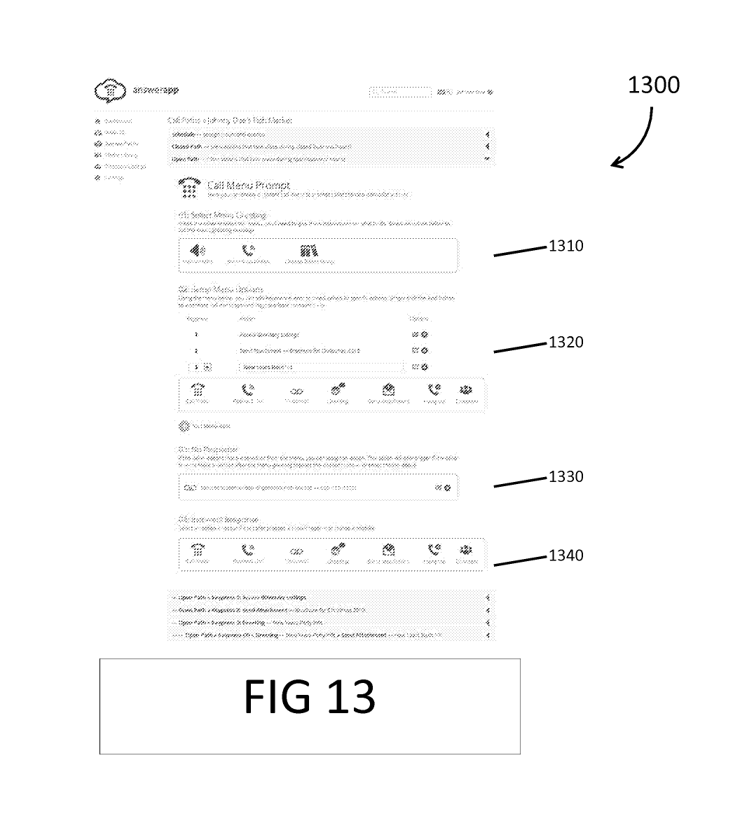

FIG. 13 shows a prompt configuration screen 1300 for configuring response prompts according an embodiment. Screen 1300 enables a user to configure the process for prompting a caller to take particular actions. In FIG. 13, these prompts are defined as part of the open path, and used for answering calls that are received during a business's open hours. Screen 1300 includes a greeting selection section 1310, a menu option section 1320, a no-response section 1330, and an incorrect-response section 1340.

Greeting selection section 1310 enables the user to provide a greeting for responding to the incoming call. The user may record the greeting, upload an audio file, or choose the greeting from a library. The greeting may include instructions for the caller how to proceed.

Menu option section 1320 enables the user to configure menu options for callers. In particular, using section 1320, the user may associate pressing some keys of the caller device with actions by the answering device. The caller may thus select from among the actions by pressing the associated key. Those actions may include redirecting the call, directing the caller to the voicemail recorder or to the directory, playing a specific message, sending an attachment to the caller device, or terminating the call.

No-response section 1330 enables the user to configure the answering device to perform one or more actions if the caller does not make a selection. Those actions may include directing the call to the voicemail recorder or terminating the call.

Incorrect-response section 1340 enables the user to configure the answering device to perform one or more actions if the caller makes an incorrect selection, such as a selection that is not among the offered selections. Those actions may include, for example, repeating the menu options, directing the call to the voicemail recorder, terminating the call, or some of the other actions mentioned above.

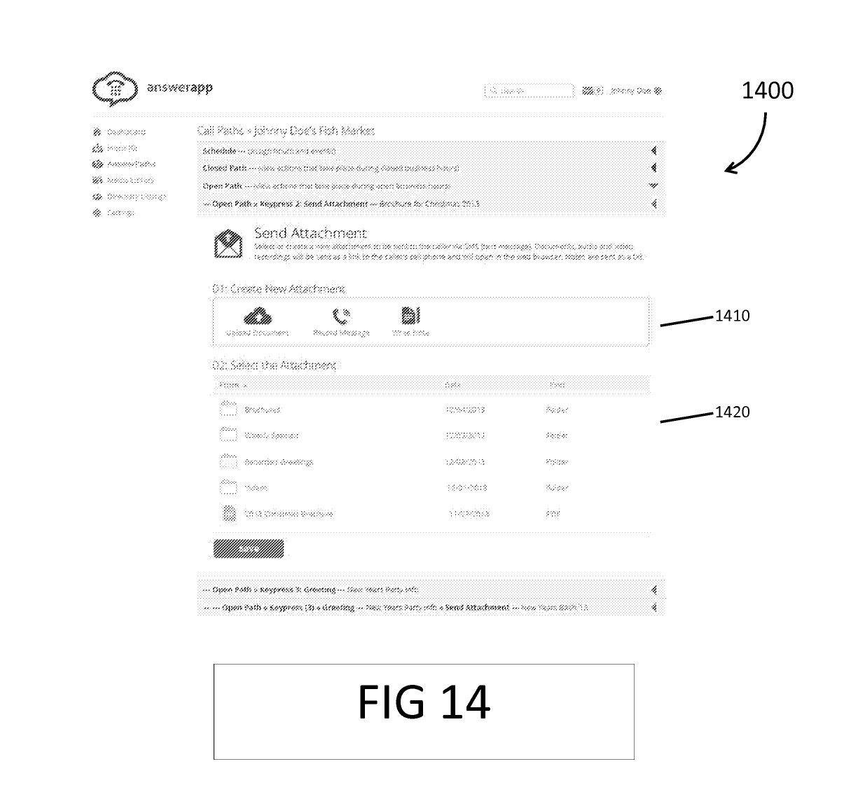

A call path may also include sending an attachment. FIG. 14 shows an attachment provision screen 1400 according an embodiment. Screen 1400 enables a user create or select an attachment to be sent to a caller device. The attachment may be in one or more of different formats, such as audio, video, image, or text format. Screen 1400 includes an attachment creation section 1410 and an attachment selection section 1420.

Attachment creation section 1410 enables the user to create a new attachment. A user may, for example, record an audio message, write a text message, or upload a file from a user's device, such as a computer.

Attachment selection section 1420 enables the user to select an attachment from a set of pre-existing files. The pre-existing files may reside, for example, in a multi-media library. The files may include pre-existing brochures, pre-recorded greetings, audio files, or video files.

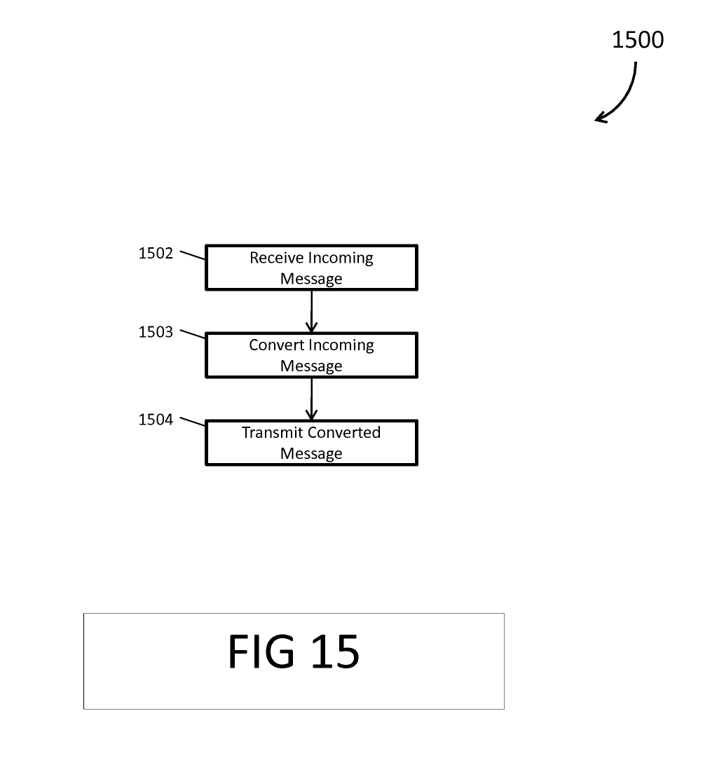

In some embodiments, the system enables the user to convert an incoming message from one format to another. FIG. 15 shows a flowchart of a method 1500 for such conversion according to some embodiments. In various embodiments, the conversion may be performed by the answering device or by the answering server.

In block 1502, an answering device receives an incoming message. The incoming message may be, for example, in an audio or a text format. An audio message may be a voicemail left by a caller.

In block 1503, the answering system converts the message from its format into another format. The system may, for example, convert an audio voicemail to a text format. In some embodiments, the system converts the message to a format that is more usable for the user of the answering system. The user may, for example, prefer to receive the incoming audio messages as text displayed in a text format.

In block 1504, the system transmits the converted message to one or more users. The system may, for example, transmit the text version of the message to the users via an electronic mail or an instant text message.

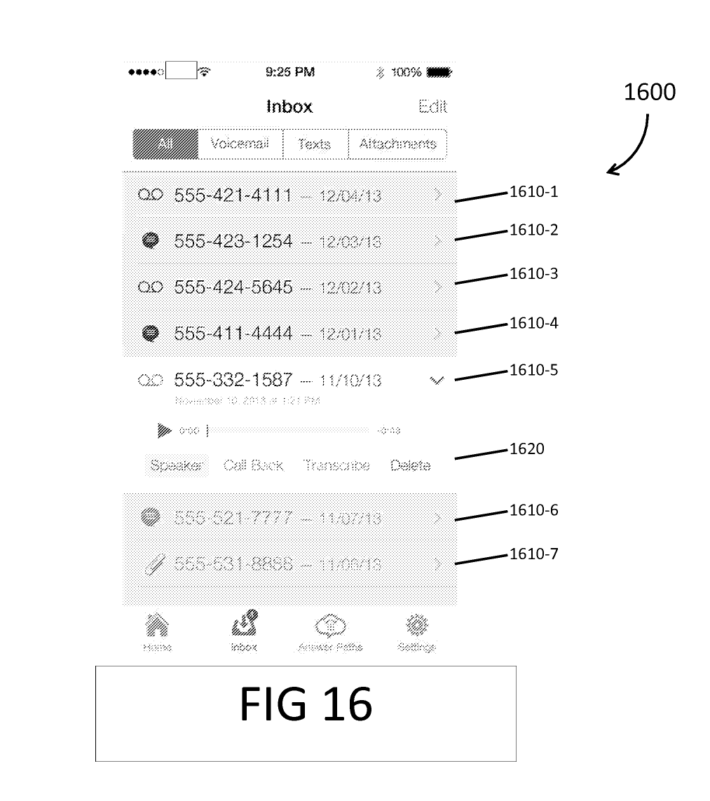

FIG. 16 shows an inbox interface 1600 for reviewing and converting incoming messages according to one embodiment. Interface 1600 lists incoming messages 1610, in particular seven messages 1610-1 to 1610-7. Some of these messages are in audio format, e.g., messages 1610-1, 1610-3, and 1610-5. Some other messages are in text format, e.g., messages 1610-2, 1610-4, and 1610-6. A user may review each message by selecting the message. In particular, the user may listen to the audio messages, or open the text messages in a display. Moreover, in section 1630, the user can choose to transcribe an audio message into a text message. In some embodiments, the user may also choose to convert a text message into other formats, such as an audio format.

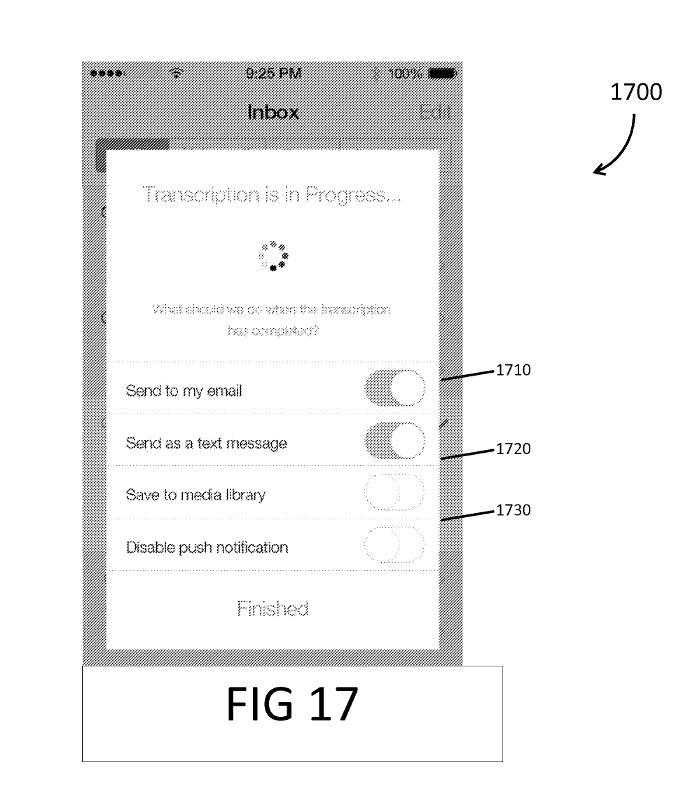

FIG. 17 shows a transcription window 1700 according to an embodiment. Transcription window 1700 may be presented to the user while the transcription is in progress. Moreover, once the transcription is complete, window 1700 enables the user to choose what to do with the transcribed message. In particular, the user may choose to send the transcribed message to a recipient via an email (section 1710) or via a text message (section 1720), or to save the message in a media library (section 1730).

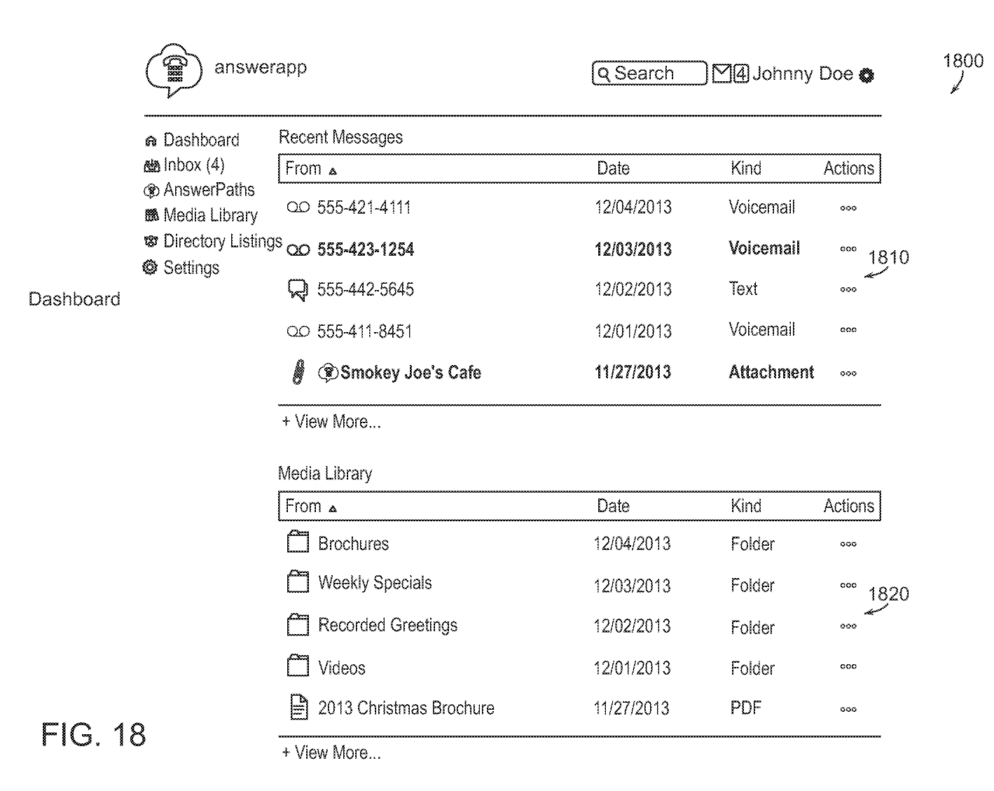

Some embodiments provide an interface to a user for accessing the items stored by an answering service independent of the answering device. FIG. 18 shows an answering service dashboard 1800 that provides such an interface according to an embodiment.

Dashboard 1800 includes an inbox summary section 1810 and a media library section 1820. Inbox summary section 1810 lists a subset of the incoming messages stored by the answering service. Section 1810 provides, for each message, an identification of the calling device, such as a phone number; and a date and a kind, such as the format, of the message.

Media library section 1820 lists a set of items stored in the multi-media library. Section 1820 provides, for each item, a name, a date, and a kind, such a folder or an individual item.

In some embodiments, a user can access an interface such as dashboard 1800 through a device, such as computer, via an internet connection. The information may be stored in one or more answering servers and accessed through the World Wide Web. A user may log into the server from any internet connection. Upon such logging, the user can access the dashboard interface, and review or modify the information shown in the dashboard.

In some embodiments, a telephone device connects to more than one telephone lines. Of the multiple telephone lines, one line may be a primary line, used as the main telephone line. The telephone device may make calls or receive calls made to the device's number firstly through the primary line. The remaining lines, on the other hand, may be secondary lines, used for secondary uses.

The secondary uses may include, for example, call waiting. The telephone system may direct an incoming call to a secondary line if the primary line is busy.

The secondary use may also include conference calling, as follows. A user may communicate with a first caller on the primary line through a first communication channel. The user may then put the first caller on hold and, using a secondary line, call a second caller and set up a second communication channel. The user may then combine the two communication channels and create a conference call among all three callers. Similarly, a conference call among more than three callers can be enabled by using more than one secondary lines. In some embodiments, the telephone device with multiple telephone lines is a mobile device.

Some embodiments utilize the multiple lines of a telephone device to configure the device as an answering device. In particular, the embodiments may use the secondary lines for the answering service.

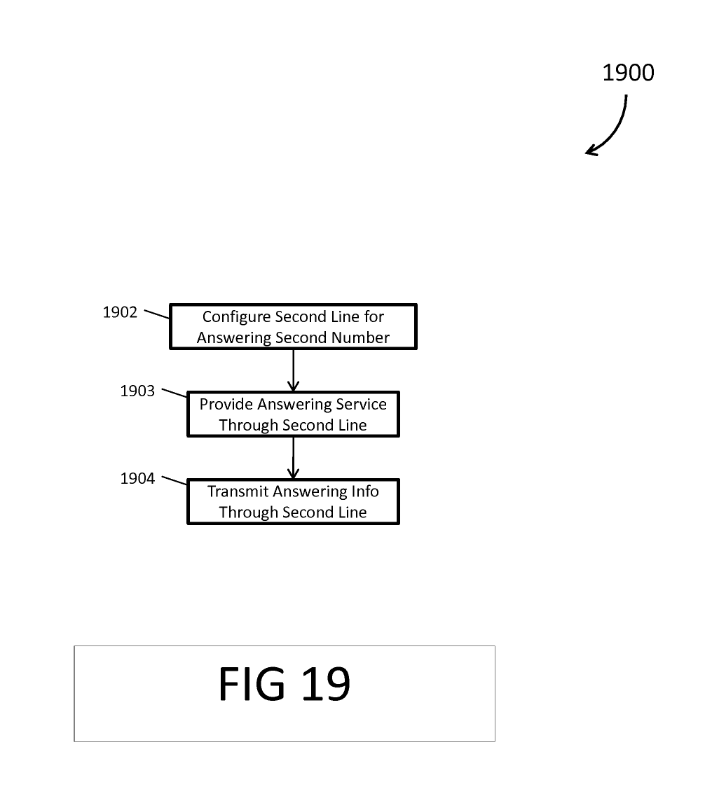

FIG. 19 shows a flowchart 1900 for configuring a telephone device as an answering device according to some embodiments. The telephone device connects to more than one telephone lines. A first telephone line may be configured as the primary telephone line of the telephone device that has its own phone number.

In block 1902, a second line of the telephone device is configured to answer calls made to a second phone number that is different from the phone number of the telephone device. The system may enable a user to make such configuration via an answering service configuration interface. One such capability is shown in FIG. 4 as the “Add Additional Extension” option. The answering service may configure the telephone lines such that calls made to the second phone number are directed to the second line. Alternatively, a second telephone device may be associated with the second telephone number and may receive calls made to that number. The second telephone device may be configured to redirect such calls to the second line of the first telephone device for the calls to receive an answering service. Such redirecting may occur, for example, if the calls to the second telephone number are not answered after a preset number of rings.

In block 1903, the telephone device is configured to provide answering service to the second telephone number. In some embodiments, the answering service may include answering to the call with one or more actions, such as greeting or prompting, as detailed here.

In block 1904, the telephone device responds to calls made to the second telephone number by transmitting information, such as audio or text messages, via the second telephone line. Using this mechanism, a user may utilize a user's mobile phone to respond to calls made to more than one telephone numbers. In particular, a user may use the same mobile phone to answer calls made to the user's personal and business phone numbers.

In some embodiments, different service providers handle different lines of the same telephone. In some embodiments, the system directs the calls made to each line to its corresponding service provider. In various embodiments, each service provider may provide telephone service, answering service, or both, to the corresponding line. In some embodiment, a service provider may be a telephone carrier company. In some embodiments, different telephone lines may correspond to phone numbers in different regions or countries. Each region or country may be serviced by its own service provider or telephone service carrier.

The foregoing description of the embodiments has been presented for purposes of illustration only. It is not exhaustive and does not limit the embodiments to the precise form disclosed. Those skilled in the art will appreciate from the foregoing description that modifications and variations are possible in light of the above teachings or may be acquired from practicing the embodiments. For example, the described steps need not be performed in the same sequence discussed or with the same degree of separation. Likewise various steps may be omitted, repeated, or combined, as necessary, to achieve the same or similar objectives. Similarly, the systems described need not necessarily include all parts described in the embodiments, and may also include other parts not described in the embodiments. Accordingly, the embodiments are not limited by the above-described details, but instead are defined by the appended claims in light of their full scope of equivalents.

1. A method for providing answering service via an answering device, the method comprising:
associating an answering service for a target telephone number of a user with the answering device;
enabling the answering device to receive a call directed from a caller device to the target telephone number;
storing an answering message; and
configuring the answering device to send back the answering message to the caller device in response to receiving the call.

2. The method of claim 1, further comprising configuring the answering device to send back the answering message to the caller device in response to receiving the call when a condition is satisfied.

3. The method of claim 2, wherein the condition is based on a date of the call or a time of the day of the call.

4. The method of claim 2, wherein the condition is based on a status of a business associated with the target telephone number.

5. The method of claim 2, wherein the condition is based on an origin of the call or a type of the caller device.

6. The method of claim 2, wherein the condition is satisfied when the call is received at a specific occasion.

7. The method of claim 2, wherein the answering message is one of a plurality of answering messages, and wherein the method further comprises enabling each answering message of the plurality of answering messages to be sent back to the caller device in response to receiving the call and when a corresponding condition of a plurality of conditions is satisfied.

8. The method of claim 7, wherein each of the plurality of conditions are satisfied at one of a plurality of time ranges.

9. The method of claim 1, wherein the answering message is stored in an answering server.

10. The method of claim 1, further comprising including in the answering message a pre-recorded message selected from a message library.

11. The method of claim 10, wherein the message library includes generic messages configured to be purchased and included in the answering message.

12. The method of claim 1, further comprising:
receiving, by the answering device, an incoming message delivered by the call;
converting, via a converter module, the incoming message to a text message; and
transmitting the text message to a recipient device.

13. The method of claim 12, wherein the recipient device is a display screen, a fax machine, or a smartphone.

14. The method of claim 12, wherein the converter module is included in the answering device.

15. The method of claim 12, wherein the converter module is included in a server device configured to communicate with the answering device.

16. The method of claim 1, further comprising:
receiving, by the answering device, an incoming message delivered by the call; and
storing the incoming message at an internet location accessible via an internet connection.

17. The method of claim 16, wherein the internet location is accessible via a world wide web connection.

18. The method of claim 16, wherein storing the incoming message includes storing one or more of an audio recording of the incoming message and a text rendition of the incoming message.

19-51. (canceled)
